(19) United States
(12) Patent Application Publication
(10) Pub. No.: US 2007/0264511 A1
(43) Pub. Date: Nov. 15, 2007

(54) Method and composition for forming a coloured coating on a metallic surface

(76) Inventors: Roberto Ponzellini, Nova Milanese (IT); Franco Falcone, Lodi (IT); Brunetta Lampreda, Bareggio (IT); Stefano Porro, Lentate sul Seveso (IT)

Correspondence Address: FULBRIGHT & JAWORSKI, LLP, 666 FIFTH AVE, NEW YORK, NY, 10103-3198, US

(21) Appl. No.: 11/431,133

(22) Filed: May 9, 2006

(51) Int. Cl. B05D 3/12; B05D 7/00; B32B 15/04

(52) U.S. Cl. 428/457; 427/327; 427/409

(57) ABSTRACT

The invention concerns a method for forming a coloured coating on a metallic surface by contacting the surface of a metallic coil or of a metallic part with an aqueous acidic composition on the base of a source of titanium and at least one complex fluoride and of at least one modified tannin compound, of at least one other polyphenolic compound, of at least one reaction product of these e.g. with titanium or any combination thereof, whereby a coating is generated with the aqueous acidic composition having a well visible intensive colour.

### FIELD OF THE INVENTION

This invention relates to a method of forming a coloured coating on a metallic surface by contacting the surface of a metallic coil or of a metallic part with an aqueous acidic composition, whereby a coating is generated with the aqueous acidic composition having a well visible intensive colour. It relates further to an aqueous acidic composition for the generation of this coating and to such a coloured coating.

The invention is particularly concerned with a conversion coating on surfaces of aluminium, of any aluminium alloy, of magnesium, of any magnesium alloy, titanium, of any titanium alloy or any combination especially of these metallic materials.

### BACKGROUND OF THE INVENTION

There is a long-term desire for coloured coatings, as coatings with a well visible colour having a thickness e.g. in the range from about 0.02 to 2 μm should be well seen and optionally even controlled for their coating quality, homogeneity etc. It would be favourable if this coloured coating could be seen on a certain distance, e.g. of about 10 m, to get a certain visual impression of the quality of the coating for controlling the quality even from a certain distance, whereas—of course—it is more often possible to observe details of the coating quality below 1 m.

Coloured coatings like yellow or green chromate conversion coatings are well known in the art of surface treatment of metallic components for corrosion protection. But the chromates—especially such having Cr⁶⁺—are very toxic. Over the years there have been numerous attempts for the replacement of chromating chemicals by ones that are less hazardous to health and to environment. In the search for alternatives, research has been conducted for conversion coatings based on less toxic conversion coatings like such on the base of molybdates, tungstates, rare earth element compounds, tannin compounds, dyes and coloured pigments. But such coloured coatings often did not fulfill all requirements needed like a high paint adhesion and a high corrosion protection or are still too toxic or both. Some of them are difficult to generate as there is only a very small chemical working window. Others show only very slight colours so that there is no possibility of any visual control from a distance of some meters.

Accordingly, it is an object of the present invention to provide a conversion coating for the surface of a metallic material which overcomes, or at least alleviates, one or more of the disadvantages or deficiencies of the prior art.

It is also an object of the present invention to provide an aqueous conversion coating composition for use in providing a conversion coating on a metallic surface.

Further on, it is an object of this invention to propose such a method to suit industrial requirements of short time formation of a well visible coloured coating for paint adhesion and corrosion protection.

Surprisingly, it has been discovered that the use of an aqueous acidic composition containing at least one modified tannin compound in the presence of titanium leads to a coating of intensive yellow colour which may be well applied to aluminium rich metallic surfaces.

### SUMMARY OF THE INVENTION

According to the present invention, there is provided a method for forming a coloured coating on a metallic surface by contacting the surface of a metallic coil or of a metallic part with an aqueous acidic composition which is a solution or a dispersion whereby the composition or the composition after chemical interaction with the metallic surface or with its surface impurities or any combination thereof contains 1.) a source of titanium and at least one complex fluoride or at least one titanium complex fluoride or any combination thereof as well as 2.) at least one modified tannin compound, at least one other polyphenolic compound, at least one derivative of these, at least one reaction product of these e.g. with titanium or any combination thereof, whereby a coating is generated with the aqueous acidic composition having a well visible intensive colour.

The present invention also provides an aqueous acidic composition having a composition as claimed in any of the claims.

Finally, it concerns a coloured coating generated with a method according to the invention as well as the use of an article having a metallic surface which is coated with a method according to the invention in architectural applications, for the production and use of white goods like refrigerators or as elements like profiles to be used for shower cabins or other construction elements.

### DETAILED DESCRIPTION OF THE PREFERRED EMBODIMENTS

Surprisingly, it has been discovered that the addition of a modified tannin compound in the presence of a source of titanium and perhaps even of aluminium or any other cation or metal containing compound to an aqueous acidic composition for conversion coating enables the formation of intensively coloured coatings. If the same experiment would be performed without any titanium content, but instead of it with a zirconium content, there was only a slight yellowish coloured coating generated which was significantly less coloured than those coatings generated with a titanium content.

The invention will now be described in detail and with particular reference to its use for aluminium and aluminium alloys, but it is believed that it may be used for metallic materials like aluminium, aluminium alloys, magnesium, magnesium alloys, steels, titanium, titanium alloys, zinc, zinc alloys or any combination of these. In particular, the metallic materials to be primarily discussed in the following are aluminium and aluminium alloys, particularly aluminium alloys of the 1000, 3000, 5000 and 6000 series. The metallic material may be applied in all possible shapes, e.g. as profiles, sheets, strips, tubes, wires and other parts. The term “coil” as used herein is identical with the term “strip”. If the coil is cut into pieces, they are seen to be metallic parts. Metallic profiles, rods and wires, which may have a considerable length, are seen to belong to metallic parts too.

The conversion coating step forms part of a method which—in a similar way—is often described in the literature and is the practised custom in the industries and which may include at least one of the following steps:
cleaning, preferably with an aqueous, alkaline or acidic cleaner,
pickling, often in a strongly alkaline or strongly acidic solution,
deoxidizing, often in an acidic solution,
conversion coating,
final rinsing, preferably with de-ionized water,
applying a special sealant or a post-rinse or both,
primer coating,
applying at least one further organic coating,
coating with an adhesive,
joining.

Many of these steps may be separated by one or more steps of rinsing with water thus reducing carry-over of processing chemicals into the next treatment stage.

Preferably, there is at least one alkaline cleaning step, at least one acidic cleaning step, at least one alkaline etching step, at least one pickling step, at least one deoxidation step, at least one desmutting step, at least one rinsing step or any combination of such steps before the conversion coating with the aqueous acidic composition according to the invention.

The cleaning, especially an acidic cleaning, may preferably be performed at a temperature in the range from 10 to 60° C. for about 0.5 to 20 min with adequate aqueous compositions, especially with aqueous compositions which may contain at least one or at least two components selected from the group of hydrofluoric acid, sulfuric acid, nitric acid, phosphoric acid, sulfonic acid, citric acid, gluconic acid, another carboxylic acid, a bifluoride, caustic soda, any of their derivatives, any surfactants and any additives. An alkaline etching may be conducted with an aqueous solution which may contain caustic soda solution and optionally at least one carboxylic acid or any of their derivatives. In some cases it is preferred to gain an etching rate in the range of about 0.5 to 3 g/m².

The deoxidizing/desmutting may be carried out with an acidic solution, such as those containing nitric acid and hydrofluoric acid or containing hydrofluoric acid and phosphoric acid or containing sodium bifluoride or containing Fe³⁺ and sulphuric acid or containing Fe³⁺ and nitric acid.

Considering the demand of a chromate-free conversion coating, standard chromate containing deoxidizers are not recommended to be used in a process according to this invention.

If the possible steps of cleaning, pickling and deoxidizing are used, a clean metallic surface should be prepared, free from dirt, oil and greases, as free as possible from oxides, and therefore very reactive towards the conversion coating step itself. The specific chemistry and process conditions will depend very much on the state of the metal surface which is to be treated. A heavily oxidized aluminium surface, for instance, certainly will require a pickling step to remove the relatively thick oxide layer from the surface.

The conversion coating composition may preferably have a pH in the range from 1 to 6, more preferred in the range from 1.5 to 5, most preferred in the range from 2 to 4.5. It may preferably be applied at a pH in the range from 2.5 to 4.2, more preferred in the range from 2.8 to 4.0.

Preferably, the conversion coating composition has a temperature in a range from 5 to 90° C., more preferred in a range from 12 to 80° C., most preferred in a range from 18 to 70° C., especially in a range from 22 to 60° C. or in a range from 25 to 50° C. or in a range from 30 to 45° C.

It has been observed that the aqueous composition may show in many embodiments a well visible colour, whereby there may be a colour change when there is added at least one compound on the base of tannin or of polyphenolic compounds to the aqueous composition containing any source of titanium or vice versa. Therefore, it is assumed that the coloured compound(s) is/are at least one complex e.g. of titanium with at least one compound on the base of any tannin compound, of any other polyphenolic compound or both.

It has been observed that the pH, the concentration of the main compounds and the temperature may in many embodiments influence the colour or the intensity of the colour or both of the solution or of the coating or of both. In some embodiments according to the invention, the solution having a low pH may be clear and a bit of a lighter colour than a solution having a higher pH, which then may be a bit darker and sometimes a bit less clear. It has further on been observed that the temperature of the composition may in several embodiments influence the colour or the intensity of the colour or both of the solution or of the coating or of both so that the colour of the composition or of the coating or both may be a bit more yellowish and a bit more intense at a temperature of 40 to 50° C. than at 20 to 30° C. Additionally, it has been observed that the intensity of the colour of the generated coating is in about proportional to the amount of titanium to be found in this coating, whereby the titanium is measured as the element. The content of titanium was measured with a device Portaspec, X Ray Spectrograph Model 2501, made by Cianflone Scientific Instruments Corp., PA., U.S.A. It may be in the range from 2 to 40 mg/m² for a yellowish coating and may be in the range from 8 to 50 mg/m² for a yellow coating. On the other hand, there was no very significant dependency found for the intensity of the colour of the generated coating in dependency from the content of the modified tannin compounds or its reaction products or both.

In the method according to the invention, the pH of the composition may sometimes or often be adapted by an addition of any acidic or any alkaline compound, especially to optimize the colour intensity of the generated coating or the stability of the composition or any combination thereof. Preferably, there is added at least one acid like hydrofluoric acid, hydrochloric acid and/or any organic acid on the base of carboxylic acids or at least one alkaline metal hydroxide, ammonium hydroxide and/or at least one amine.

The conversion coating composition forms a thin layer on the metallic surface. The corrosion protecting properties of this coating may be further improved by adding a sealant to the final rinsing solution. This technique is well known in the industries. Suitable sealants or post-rinses or both may be based on silicates, phosphates, silanes, fluorotitanates or fluorozirconates, special polymers like polyvinylphenole derivatives or like—sometimes modified—polyacrylates or any combination thereof. As with the deoxidizer, the well-known chromate containing conversion coating compositions, sealants or post-rinses could be used in principle, yet would not make much sense in an otherwise chromate-free process.

The composition may preferably contain a titanium complex fluoride and optionally a zirconium complex fluoride. The complex fluorides of titanium and of zirconium show e.g. four or six fluorine atoms.

The composition preferably contains at least one titanium compound or titanium cations or both which may favourably be contained in the composition in a concentration in a range from 0.1 to 1000 mg/L measured as elemental Ti, more preferred in a range from 1 to 600 mg/L, most preferred in a range from 5 to 400 mg/L, especially in a range from 20 to 300 mg/L or in a range from 60 to 200 mg/L.

The composition may preferably contain at least one zirconium compound or zirconium cations or both which is contained in the composition in a concentration of about zero or in a range from 0.1 to 1000 mg/L measured as elemental Zr, more preferred in a range from 1 to 600 mg/L, most preferred in a range from 5 to 400 mg/L, especially in a range from 20 to 300 mg/L or in a range from 60 to 200 mg/L.

The composition may preferably contain at least one compound selected from titanium compounds, complex fluorides and titanium complex fluorides in the composition in a concentration in a range from 0.01 to 200 g/L, more preferred in a range from 0.1 to 200 g/L, most preferred in a range from 0.5 to 10 g/L.

The composition may preferably contain titanium complex fluoride in the composition in a concentration in a range from 0.01 to 100 g/L, more preferred in a range from 0.05 to 50 g/L, most preferred in a range from 0.1 to 10 g/L.

The composition may preferably contain at least one zirconium compound which may be contained in the composition in a concentration in a range from 0.01 to 100 g/L, more preferred in a range from 0.05 to 50 g/L, most preferred in a range from 0.1 to 10 g/L.

According to the method according to the invention, the titanium compound(s) and the zirconium compound(s) are preferably contained in the composition in a weight ratio of the elemental contents of Ti:Zr from 20:1 to 1:10, more preferred in a ratio from 12:1 to 1:5, most preferred in a ratio from 8:1 to 1:2 or from 6:1 to 1:1, especially from 5:1 to 2:1, e.g. from 4:1 to 3:1. For example, a specific composition may e.g. contain 239 mg/L Ti and 91 mg/L Zr, measured as the elements.

Preferably, the at least one zirconium complex fluoride is contained in the composition in a concentration in a range from 0.01 to 100 g/L, more preferred in a range from 0.1 to 30 g/L, most preferred in a range from 0.5 to 10 g/L.

Preferably, the concentration of the sum of titanium complex fluorides and zirconium complex fluorides in the composition is in a concentration in a range from 0.01 to 200 g/L, more preferred in a range from 0.1 to 80 g/L, most preferred in a range from 0.5 to 20 g/L.

The composition may preferably contain at least one coloured compound which is at least one modified tannin compound, at least one other polyphenolic compound, any of their derivatives, any of their reaction product(s) or any combination thereof, which is/are at least one complex, e.g. with titanium, aluminium, magnesium, yttrium, any rare earth element or any combination thereof, which may be contained in the composition or in the coating or both.

The coloured compound(s) of the at least one modified tannin compound, of at least one other polyphenolic compound, any of their derivatives, of their reaction product(s) or of any combination thereof may probably be a complex which may often contain titanium, which coloured compound may be contained in the composition or in the coating or both. In some cases, it may even contain at least one further cation besides or except of titanium.

The modified tannin compounds, the other polyphenolic compounds, their derivatives and their reaction products are contained in the composition in a concentration in a range from 0.1 to 80 g/L, more preferred in a range from 0.3 to 50 g/L, most preferred in a range from 0.5 to 20 g/L or from 0.8 to 10 g/L or from 1 to 4 g/L.

It has been found in the embodiments checked that the colour and the other properties of the generated coatings are in a wide extent independent from the content of modified tannin compounds, of any other polyphenolic compounds, of their derivatives and of their reaction products, which may be e.g. in a range from 0.5 to 5 g/L or from 1 to 4 g/L without an clear change of properties of the generated coating, as the content of the cations, especially of titanium, seems to be more important.

The at least one tannin compound may have been prepared from at least one tannin compound like any natural tannin compound, like any purified natural tannin compound, like tannic acid or any combination thereof.

The reaction product(s) may be generated in the composition or by reaction with atoms or ions or both of the metallic coating or with its surface layer(s) or impurities upon it or with any combination thereof, e.g. on the metallic surface. The sources of titanium and of the complex fluoride may be: a) at least one titanium compound and at least one complex fluoride or b) titanium ions and at least one complex fluoride or c) at least one titanium complex fluoride or any combination thereof. The source of the coloured modified tannin compound may be a) at least one modified tannin compound, at least one other polyphenolic compound, at least one of their derivatives or any combination thereof, b) at least one reaction product of at least one modified tannin compound, of at least one other polyphenolic compound, of their derivatives, or of any combination thereof e.g. with titanium or both. At least one compound of the compounds b) has an intensive colour, probably often a complex with titanium, preferably in the generated coating.

It is well-known in the art that a tannin compound like any natural tannin compound, like any purified natural tannin compound, like tannic acid, like any chemically related polyphenolic compound or any combination thereof as well as any thin coating (e.g. of a thickness in the range from 0.03 to 0.3 μm thickness) prepared with a composition having at least one of these compounds may have a nearly colourless, a slightly yellow, slightly orange, slightly red or slightly brown tint, but in a thin coating having a coating thickness e.g. of about 0.05 μm and having only up to 50% of weight of such compounds in this coating, the colour of the coating is much too light—in opposite to the coating according to the invention, which has a significantly more intensive colour.

Often, the tannin based compounds and other polyphenole based compounds sold commercially have a certain high impurity content or a concentration of the main compound e.g. in a range from 60 to 98% by weight or both which may influence a) the colour or clearness or turbidity or any combination thereof of the composition or b) the colour or the colour intensity or both of the generated coating or both. This too may cause a higher number of tannin compounds, of other polyphenolic compounds of reaction products of these or any combination thereof present in the composition or in the coating or both according to the invention. The impurities may be other tannin products, similar compounds, similar reaction products as well as other impurities, depending on the starting material selected.

The composition may preferably contain the at least one modified tannin compound, the at least one other polyphenolic compound, any derivative of these, any reaction product of these or any combination thereof is at least one ester of gallic acid, of digallic acid, of ellagic acid(s), of tannic acid(s), of any other polyphenolic compound, of any derivative of these or of any combination of these which is at least one intensively coloured compound or is the chemical base for the reaction to at least one intensively coloured compound or both. The at least one modified tannin compound, the at least one other polyphenolic compound, any derivative of these or any combination thereof is at least one polymerization product of probietinidin or a derivative of it or both which is at least one intensively coloured compound or is the chemical base for the reaction to at least one intensively coloured compound or both. The composition may preferably contain at least one modified tannin compound, at least one other polyphenolic compound, any derivative of these or any combination thereof that has at least one group of quinic acid, of a carbohydrate, of a glucose, of any chemically related compound or of any combination thereof. The composition may preferably contain at least one modified tannin compound which is a condensed tannin compound or a derivative of it or both.

The composition according to the invention may further on preferably contain at least one complexing agent. It may preferably contain as the at least one complexing agent like EDTA, HEDTA, at least one carboxylic compound or any combination thereof, especially in a concentration in a range from 0.1 to 100 g/L, more preferred in a range from 0.5 to 80 g/L, most preferred 1 to 50 g/L. Such complexing agents are well known in the art.

The composition according to the invention may further on preferably contain ions of free fluoride, preferably in a concentration in a range from 0.01 to 2 g/L, more preferred in a range from 0.05 to 1.5 g/L, most preferred in a range from 0.1 to 1 g/L. Favourably, there is added hydrofluoric acid to the composition, preferably in a range from 0.01 to 4 g/L, more preferred in a range from 0.05 to 3 g/L, most preferred in a range from 0.1 to 2 g/L. Preferably, the free fluoride may be added as at least one added compound selected from the group consisting of hydrofluoric acid, any monofluoride and any bifluoride or may be at least partially gained from any chemical reaction or may be added and gained from such chemical reaction(s). Such compounds may be added as the acid, as a sodium compound, as a potassium compound, as a fluoro complex compound, as an ammonium compound or in any combination thereof. If there is only added a compound like an ammonium complex fluoride, it may happen that the content of the free fluoride is not an essential amount of free fluoride.

The composition according to the invention may further on preferably contain at least one compound selected from the group consisting of silanes, siloxanes, polysiloxanes, their hydrolysation products and their condensation products, preferably in a concentration in a range from 0.01 to 10 g/L, more preferred in a range from 0.05 to 5 g/L, most preferred in a range from 0.1 to 2 g/L. Such compounds often aid to optimize the adhesion and corrosion protection of the generated coatings.

The composition according to the invention may further on preferably contain at least one compound selected from the group consisting of organic polymers, organic copolymers, organic blockcopolymers, silylated organic compounds and their reaction products, preferably in a concentration in a range from 0.01 to 50 g/L, more preferred in a range from 0.1 to 32 g/L, most preferred in a range from 0.5 to 15 g/L. Such compounds often aid to optimize the adhesion and corrosion protection of the generated coatings.

The composition according to the invention may further on preferably contain at least one inorganic compound in the form of fine particles, preferably in a concentration in a range from 0.01 to 10 g/L, more preferred in a range from 0.05 to 3 g/L, most preferred in a range from 0.1 to 1.5 g/L. Such compounds often aid to optimize the corrosion protection of the generated coatings. Such inorganic particles may be often powders of oxides or silicates or both, but of course there may be added a lot of other inorganic powders too. Preferably, such powders are based on at least one compound selected from oxides, silicates, SiO₂, modified SiO₂, corrosion inhibitors, UV absorbers and any combination thereof, especially such powders which are sometimes used as addition in organic or essentially organic coatings like in primers and lacquers. Such powders may have particle sizes or a mean particle size preferably predominantly below 1 μm or totally below 1 μm or they are nanoparticles. The particle size distribution of such powders may have one, two or several peaks.

Preferably, the composition additionally contains at least one compound or at least one type of cations or both selected from the group consisting of aluminium, magnesium, yttrium and any rare earth element like cerium, preferably in a concentration in a range from 0.005 to 20 g/L, more preferred in a range from 0.01 to 10 g/L, most preferred in a range from 0.05 to 3 g/L. Such cations seem to aid to generate a better colour of the coating at least in few cases.

In some embodiments, the composition may additionally contain at least one defoamer, at least one surfactant, at least one biocide, at least one wetting agent or at least one further additive or any combination thereof, preferably in a concentration of such agents in a range from 0.005 to 6 g/L, more preferred in a range from 0.01 to 4 g/L, most preferred in a range from 0.05 to 2 g/L. Preferably, the defoamer(s) are present in a concentration in a range from 0.001 to 3 g/L, more preferred in a range from 0.01 to 0.5 g/L. Preferably, the surfactant(s) are present in a concentration in a range from 0.001 to 6 g/L, more preferred in a range from 0.005 to 2 g/L, most preferred in a range from 0.01 to 0.5 g/L. Preferably, the further additive(s) are present in a concentration in a range from 0.001 to 3 g/L, more preferred in a range from 0.005 to 2 g/L, most preferred in a range from 0.01 to 1 g/L.

Preferably, the composition additionally contains at least one particulate inorganic or organic compound, at least one complexing compound like a carboxylic compound or any combination thereof, preferably in a concentration of such compounds in a range from 0.01 to 20 g/L, more preferred in a range from 0.1 to 6 g/L, most preferred 0.2 to 3 g/L. Preferably, the complexing compound(s) are selected from the group consisting of EDTA, HEDTA, at least one carboxylic compound and at least one chelate, more preferred the complexing compound(s) are selected from hydroxycarboxylic acids, their salts and other complexing compounds like on the base of acetylacetonate, alkanolamine, phosphonate, citrate, lactate and polylactate, especially like alkylacetatoacetate, alkylenediamine tetraacetate and ammonium lactate. Preferably, the complexing compound(s) are present in a concentration in a range from 0.01 to 5 g/L, more preferred in a range from 0.05 to 3 g/L, most preferred 0.1 to 1 g/L.

Preferably, the metallic surfaces are contacted with the conversion coating composition for a time of 1 second to 20 minutes, more preferred in a range from 3 seconds to 15 minutes, most preferred in a range from 5 seconds to 10 minutes or from 20 seconds to 5 minutes.

The application of the conversion coating composition on the metallic surface may preferably be performed by brushing, dipping, immersing, spraying, squeezing, coater-coating or any combination of these.

With the method according to the invention, in some embodiments the liquid film for the conversion coating on the metallic surface is dried-on or the generated conversion coating is rinsed

With the method according to the invention, the metallic surface coated with a yellowish or yellow coating may in some embodiments be further on at least partially coated with at least one organic coating like a primer or a lacquer or with an adhesive or both. Optionally, the article having at least one metallic surface coated with a yellowish or yellow coating may be used for joining like welding, glueing or any combination thereof with at least one further component.

With the method according to the invention, a yellowish or yellow coating, which preferably has a titanium content in the range from 3 to 300 mg/m², is generated upon the metallic surface which may correspond with the coating weight measured only as elemental titanium. More preferred, the titanium content is in the range from 5 to 200 mg/m², most preferred in a range from 10 to 80 mg/m² or from 20 to 60 mg/m².

Preferably, the coloured coating has a coating weight in the range from 0.001 to 8 g/m², more preferred in the range from 0.005 to 5 g/m², from 0.01 to 2 g/m², from 0.025 to 1 g/m² or from 0.08 to 0.5 g/m². Preferably, the coloured coating has a titanium content in the range from 5 to 100 mg/m², measured as the chemical element with a device Portaspec, more preferred in the range from 10 to 60 mg/m². Preferably, the generated coating has a colour which is significantly more intensive than the colour of a typical non-modified tannin compound like a natural tannin compound or like tannic acid. Typically, they are yellowish, yellow or brownish, but of course there may be obtained similar colours too if the composition and the conditions would be modified. Preferably, the coloured coating has a corrosion resistance and a paint adhesion which is well sufficient for most applications.

Preferably, there is at least one rinsing step, at least one post-rinsing step, at least one sealing step or any combination of such steps after the coating with the aqueous conversion coating composition.

It was surprising that the method according to the invention gave an excellent coloured coating in a process with a conversion composition bath of longer stability, with a composition which often need only few substances to be added, in a process often of only low foam, generating no or nearly no sludge, whereby the generated coating may be easily removed, e.g. from the walls of the bath containers and tubes.

### EXAMPLES

The following examples illustrate, in detail, embodiments of the invention. The following examples shall help to clarify the invention, but they are not intended to restrict its scope:

Substrates

As substrates, the aluminium alloys AA-1050, AA-5005 and AA-6060 were tested in the form of profiles and of metal sheets.

Process

The parts were conversion coated using a standard process sequence for pre-treatment, conversion coating and after-treatment; the process (Table I) is one typical example of such process for the industries. The deoxidation was performed on the base of sulfuric acid, phosphoric acid and fluoride. The conversion composition was applied by spraying at ≧0.6 bar nozzle pressure. It was important to have this composition well dissolved.

Gardacid® and Gardobond® are registered trademarks of Chemetall GmbH, Frankfurt am Main, Germany.

TABLE I
Process Sequence

| | | | Temperature | Time |
|---|---|---|---|---|
| Step | Process | Chemicals | [° C.] | [sec] |
| 1 | Acidic | 15 g/L Gardobond ® | 50 | 180 |
| | cleaning | I A 1200 | | |
| 2 | Rinsing | Tap water | ambient | 60 |
| 3 | Deoxidizing | 15 g/L Gardacid ® | ambient | 120 |
| | | 33 and addition of | | |
| | | Gardobond ®-Additive | | |
| | | H 7250 | | |
| 4 | Rinsing | De-ionized water | ambient | 60 |
| 5 | Conversion | Note Table II | 50 | 180 |
| | Coating | | | |
| 6 | Rinsing | De-ionized water | ambient | 60 |
| 7 | Final | De-ionized water | ambient | 60 |
| | Rinsing | | | |
| 8 | Drying | Drier | e.g. 80 | >300 |

TABLE II
Compositions

| | Ex. | Ex. | Ex. | Ex. | Ex. | Comp. |
|---|---|---|---|---|---|---|
| g/L | 1 | 2 | 3 | 4 | 5 | Ex. 6 |
| H₂TiF₆ | 0.050 | 0.200 | 0.800 | 0.960 | 1.200 | none |
| H₂ZrF₆ | 0.025 | 0.100 | 0.400 | 0.240 | none | 1.200 |
| Modified | 0.500 | 2.000 | 4.000 | 4.000 | 4.000 | 4.000 |
| tannin | | | | | | |
| compound | | | | | | |
| Defoamer | 0.050 | 0.050 | 0.050 | 0.050 | 0.050 | 0.050 |
| Surfactant | none | 0.025 | 0.025 | 0.025 | 0.025 | 0.025 |

When mixing the components to the aqueous solutions, the solutions obtained immediately a clearly yellow or yellow-brownish colour, when there was added a modified tannin compound to a titanium containing solution or vice versa. The pH of the compositions was at about 2.8 to 3, if needed after further adjustment. These compositions were stable baths so that there were no precipitates for few weeks. They were applied by spraying. The coated substrates showed an intensive yellow coating having a coating weight in the range from 0.05 to 0.2 g/m². The coloured coating was as intensive that a certain, but sufficient visual control from a distance of 10 m was possible, e.g. for the colour intensity and for more or less excellent homogeneity of the coloured coating. The coatings showed a titanium content measured as the chemical element in the range from 10 to 30 mg/m². The coating colour was found to be a good indicator for the quality of the coating, even when seen from a distance of about 10 m. If the generated coatings had a yellow colour—it may be a lighter yellow or a darker yellow—the coating was found to be okay. In a further trial, a metal sheet of a magnesium alloy which was free from a content of aluminium, was coated with the aqueous composition of example 3 and the coating showed an identical yellow colour.

Three metal sheets coated with a composition according to one of the examples 1 to 3 were tested in the following tests:
1. Cross Hatch Test according to DIN EN ISO 2409.
2. Humidity Test according to DIN EN 50017.
3. CASS Test according to ASTM B 368-97.
4. ESS Test according to DIN EN 50021.
5. Filiform Test according to DIN EN 3665.

The coatings gave the following results:

TABLE III
Results of the laboratory investigations of the coated substrates

| | Substrate | |
|---|---|---|
| | AA 5005 | AA 6060 |
| Cross Hatch Test | Gt 0 | Gt 0 |
| Cross Hatch Test after 240 h Humidity Test | Gt 0 | Gt 0-Gt 1 |
| CASS Test 504 h | <1 | <1 |
| ESS Test 1008 h | <1 | <1 |
| Filiform Test 480 h | <1* | <1 |

*with one exception

The paint adhesion of the coating of example 2 was slightly better than of example 1. The generated coloured coatings were not only show a well visible yellow colour, but had a well sufficient corrosion protection and paint adhesion.

1-35. (canceled)

36. A method for forming a colored coating on a metallic surface by contacting the surface of a metallic coil or of a metallic part with an aqueous acidic composition which is a solution or a dispersion whereby the composition or the composition after chemical interaction with the metallic surface or with its surface impurities or any combination thereof contains 1) a source of titanium and at least one complex fluoride or at least one titanium complex fluoride or any combination thereof and 2) at least one modified tannin compound, at least one other polyphenolic compound, at least one derivative of these, at least one reaction product of these e.g. with titanium or any combination thereof, whereby a coating is generated with the aqueous acidic composition having a well visible intensive color.

37. The method according to claim 36, wherein the aqueous composition shows a well visible color.

38. The method according to claim 36, wherein the composition contains a titanium complex fluoride and optionally a zirconium complex fluoride.

39. The method according to claim 36, wherein the composition has a pH in the range from 1 to 6.

40. The method according to claim 36, wherein the at least one titanium compound or titanium cations or both are contained in the composition in a concentration in a range from 0.1 to 1000 mg/L measured as elemental Ti.

41. The method according to claim 36, wherein the at least one zirconium compound or zirconium cations or both are contained in the composition in a concentration of about zero or in a range from 0.1 to 1000 mg/L measured as elemental Zr.

42. The method according to claim 36 wherein at least one compound selected from titanium compounds, complex fluorides and titanium complex fluorides is contained in the composition in a concentration in a range from 0.01 to 200 g/L.

43. The method according to claim 36 wherein the titanium compound(s) and the zirconium compound(s) are contained in the composition in a weight ratio of the elemental contents of Ti:Zr from 20:1 to 1:10.

44. The method according to claim 36, wherein the concentration of the sum of titanium complex fluorides and zirconium complex fluorides in the composition is in a concentration in a range from 0.5 to 200 g/L.

45. The method according to claim 36, wherein the at least one colored compound of the modified tannin compound(s), of any other polyphenolic compound(s), of their derivatives, of their reaction product(s) or of any combination thereof is at least one complex.

46. The method according to claim 36, wherein the colored compound(s) is/are at least one complex e.g. of titanium with at least one compound on the base of any tannin compound, of any other polyphenolic compound or both.

47. The method according to claim 36, wherein the modified tannin compounds, the other polyphenolic compounds, their derivatives and their reaction products are contained in the composition in a concentration in a range from 0.1 to 80 g/L.

48. The method according to claim 36, wherein the at least one modified tannin compound, the at least one other polyphenolic compound, any derivatives of these, any reaction product of these or any combination thereof is at least one ester of gallic acid, of digallic acid, of ellagic acid(s), of tannic acid(s), of any other polyphenolic compound, of any derivative of these or of any combination of these which is at least one intensively colored compound or is the chemical base for the reaction to at least one intensively colored compound or both.

49. The method according to claim 36, wherein the at least one modified tannin compound, the at least one other polyphenolic compound, any derivative of these or any combination thereof is at least one polymerization product of probietinidin or a derivative of it or both which is at least one intensively colored compound or is the chemical base for the reaction to at least one intensively colored compound or both.

50. The method according to claim 36 wherein the modified tannin compound is a condensed tannin compound or a derivative of it.

51. The method according to claim 36, wherein the composition contains at least one complexing agent.

52. The method according to claim 51, wherein the at least one complexing agent is present in a concentration in a range from 0.1 to 100 g/L.

53. The method according to claim 36, wherein the composition contains ions of free fluoride, preferably in a concentration in a range of from 0.01 to 2 g/L.

54. The method according to claim 36, wherein the composition contains at least one compound selected from the group consisting of silanes, siloxanes, polysiloxanes, their hydrolysation products and their condensation products, preferably in a concentration in a range from 0.01 to 5 g/L.

55. The method according to claim 36 wherein the composition contains at least one compound selected from the group consisting of organic polymers, organic copolymers, organic blockcopolymers, silylated organic compounds and their reaction products, preferably in a concentration in a range from 0.01 to 20 g/L.

56. The method according to claim 36, wherein the composition contains at least one inorganic compound in the form of fine particles, preferably in a concentration in a range from 0.01 to 5 g/L.

57. The method according to claim 36, wherein the pH of the composition is adapted by an addition of any acidic or any alkaline compound, especially to optimize the color intensity of the generated coating or the stability of the composition or any combination thereof.

58. The method according to claim 36, wherein the composition additionally contains at least one compound or at least one type of cations or both selected from the group consisting of aluminium, magnesium, yttrium and any rare earth element, preferably in a concentration in a range from 0.005 to 20 g/L.

59. The method according to claim 36 wherein the composition additionally contains at least one defoamer, at least one surfactant or at least one further additive or any combination thereof, preferably in a concentration of such agents in a range from 0.005 to 6 g/L.

60. The method according to claim 36, wherein the composition additionally contains at least one particulate inorganic compound or any complexing compound like a carboxylic compound or both, preferably in a concentration of such compounds in a range from 0.01 to 10 g/L.

61. The method according to claim 36, wherein a well visible yellowish or yellow coating is generated.

62. The method according to claim 36, wherein a yellowish or yellow coating with a titanium content in the range from 3 to 300 mg/m² is generated.

63. The method according to claim 36, wherein there is at least one alkaline cleaning step, at least one acidic cleaning step, at least one alkaline etching step, at least one pickling step, at least one deoxidation step, at least one desmutting step, at least one rinsing step or any combination of such steps before coating or with the aqueous acidic composition.

64. The method according to claim 36, wherein there is at least one rinsing step, at least one post-rinsing step, at least one sealing step or any combination of such steps after the coating with the aqueous acidic composition.

65. The method according to claim 36, wherein the liquid film for the conversion coating on the metallic surface is dried-on or the generated conversion coating is rinsed.

66. The method according to claim 36, wherein the metallic surface coated with a yellowish or yellow coating is further on at least partially coated with at least one organic coating like a primer or a lacquer or with an adhesive or both.

67. An aqueous acidic composition comprising 1) a source of titanium and at least one complex fluoride or at least one titanium complex fluoride or any combination thereof and 2) at least one modified tannin compound, at least one other polyphenolic compound, at least one derivative of these, or at least one reaction product of these, e.g. with titanium or any combination thereof.

68. A colored coating generated with a method of claim 36.

69. The colored coating of claim 68, which has a titanium content in the range from 5 to 100 mg/m², measured as the chemical element with a device Portaspec.

70. A metallic surface coated according to the method of claim 36.
